(19) United States
(12) Patent Application Publication
(10) Pub. No.: US 2003/0094108 A1
(43) Pub. Date: May 22, 2003

(54) Controller of a double-sided printing press for controlling print density of printed matters

(76) Inventor: Masaki Shiki, Fuchu-shi (JP)

Correspondence Address: PERKINS COIE LLP, P.O. BOX 2168, MENLO PARK, CA, 94026, US

(21) Appl. No.: 10/290,876

(22) Filed: Nov. 7, 2002

(30) Foreign Application Priority Data
Nov. 22, 2001 (JP) 2001-357542

(51) Int. Cl. B41F 1/00

(52) U.S. Cl. 101/171

(57) ABSTRACT

There is provided a controller of a double-sided printing press equipped with ink feeders for controlling print density of a printed matter having front and rear sides printed by the double-sided printing press. The controller includes: a display means for displaying a density deviation between a target density value and a density value of the printed matter for each of the ink feeders; an input means for arbitrarily selecting an ink feeder to be color corrected based upon density deviations of the respective printing units displayed by the display means; and an ink amount control means for controlling the ink amount of the ink feeder selected by the input means based upon a density deviation corresponding to the ink feeder. The display means is capable of displaying a density deviation of the front side and a density deviation of the rear side, and the input means is capable of selecting an ink feeder for the front side and an ink feeder for the rear side from the ink feeders.

### BACKGROUND OF THE INVENTION

1. Field of the Invention

The present invention relates to an improvement in a controller of a double-sided printing press for controlling print density of printed matters printed by the double-sided printing press.

2. Description of the Background Art

A multiple color printing is generally performed by using four colors, namely cyan (C), magenta (M), yellow (Y) and black (Bk). For the multiple color printing, four press plates in total are provided in the printing press, corresponding to those four colors, and ink feeders are respectively provided in the press plates. Accordingly, a total of the four ink feeders are provided in the printing press for four-color printing.

FIG. 2 illustrates an example of a sheet-fed offset printing press capable of four-color printing on one side. The printing press of this type includes a total of four printing units 71, 72, 73, 74, each of which is equipped with a printing cylinder, rubber cylinder (blanket cylinder) and impression cylinder, are aligned in tandem in a sheet-transfer direction. In this arrangement, the printing cylinders are respectively provided with press plates, and ink feeders are provided in the respective printing units to feed inks to the press plates, respectively.

The first to fourth printing units 71, 72, 73, 74, which are disposed in sequence from the upstream side to the downstream side, are respectively provided with the press plates of, for example, black, cyan, magenta and yellow. Sheets of paper are sequentially fed from a sheet feeding unit, subjected to printing of each color at a corresponding unit of the printing units 71, 72, 73, 74, and hence printed in four colors.

The ink feeders are respectively provided with ink fountains, each of which includes an ink fountain roller and a blade. Ink stored in each ink fountain flows through a gap between the ink fountain roller and the blade and is fed on the outer circumference of the ink fountain roller. Ink flown out on the ink fountain roller is fed to the press plate of each printing unit via a large number of ink rollers.

The gap in each ink fountain is adjustable by opening and closing the blade. Specifically, the gap is widened by increasing the opening amount of the blade so that the amount of ink flowing out of the ink fountain is increased. On the contrary, the gap is narrowed by decreasing the opening amount of the blade so that the amount of ink flowing out of the ink fountain is decreased. Thus, in each ink feeder, the amount of ink to be fed to the press plate is adjusted by adjusting the gap, that is, the opening amount of the ink fountain.

The blade in each ink feeder is made up of ink fountain keys, which are aligned in parallel to the axial direction of the ink fountain roller (i.e., the lateral direction of a printed sheet) and which respectively have opening amounts independently adjustable.

Meanwhile, in actual printing operation, a color printed on a sheet sometimes is weaker or stronger in density value than the target density value. In order to bring such a color closer to the target density value, a so-called color correction operation must be performed. In this color correction operation, since visual inspection manually made by an operator to determine whether the print density is proper or not may not result in an accurate judgement, a color bar, which is simultaneously printed on a printed matter, is measured for that purpose. The present inventors previously developed a controller for controlling print density that is capable of easily performing color correction operation. This controller controls the amount of each ink by designating a density value of a printed matter (OK sheet), which value acts as a target value or reference, as a target density value, measuring a color bar printed on the printed matter by means of a scanning-type reflective color densitometer, calculating a density deviation with respect to the target density value, and controlling the opening amount of an ink fountain based upon the calculated density deviation. With this controller, the quality control of printed matters, which was relied on the operator's experience or hunch, can be made based upon computed numerical values, so that the proportion of broke can be reduced and hence the printing quality can be stabilized.

However, where a printing press is to print on both side of sheets, the color correction operations for the front and rear sides of sheets must be made independently of each other.

For example, when printed matters are printed on both sides by a printing press as illustrated in FIG. 2, which is a double-sided printing press equipped with a turn-over mechanism disposed between first printing unit 71 and second printing unit 72, the first printing unit 71 prints one color on a rear side of printed matters, and then the first to fourth printing units 72, 73, 74 respectively print three colors on a front side of the printed matters. The color correction operation in this double-sided printing press is so performed that a color bar on the front side of the printed matters with its both sides printed is first measured, thereby enabling a display unit to display only the data representative of density deviations of the three colors printed by the second to fourth printing units. In that state, successive measurement of a color bar on the rear side is impossible, and therefore the operator must once select a printing unit for which the color correction must be made, based upon the displayed data representative of the three colors printed on the front side. Subsequent to this selection, the ink amount of the selected printing unit is controlled based upon the density deviation corresponding to that printing unit.

Subsequent to such a series of steps of the color collection operation for the front side, a color bar on the rear side of the printed matter is measured, thereby enabling the display unit to display only the data representative of the density deviation for the first printing unit 71. Upon selection of the first printing unit, the amount of ink in that printing unit is controlled. Thus, the conventional print density controller necessitates the independent color correction operation for each of the front and rear sides.

In consideration of the above problem, it is an object of the present invention to provide a print density controller that is capable of efficiently performing the color correction in double-sided printing operation.

### SUMMARY OF THE INVENTION

According to one aspect of the present invention, there is provided a controller of a double-sided printing press equipped with ink feeders for controlling print density of a printed matter having front and rear sides printed by the double-sided printing press, which includes: a display means for displaying a density deviation between a target density value and a density value of the printed matter for each of the ink feeders; an input means for arbitrarily selecting an ink feeder to be color corrected based upon density deviations of the respective printing units displayed by the display means; and an ink amount control means for controlling the ink amount of the ink feeder selected by the input means based upon a density deviation corresponding to the ink feeder, in which the display means is capable of displaying a density deviation of the front side and a density deviation of the rear side, and the input means is capable of selecting an ink feeder for the front side and an ink feeder for the rear side from the ink feeders.

With the controller having the above arrangement, the density values of both the front and rear sides of printed matters, and ink units for the both sides, which must be color corrected, can be selected at a time. As a result, the color corrections for the front and rear sides can be successively made, thereby achieving an efficient color correction operation in a short period of time as compared with a conventional operation. Also the proportion of broke can be reduced.

The display means may be designed to display the density deviation of the front side and the density deviation of the rear side on a single panel in an integral manner. With this display means, the operator can instantly determine the necessity of color corrections of the front and rear sides by observing the single panel.

The display means may be designed to selectively display a panel that displays the density deviation of the front side and a panel that displays the density deviation of the rear side. With this display means, these panels are respectively designed exclusively for the front and rear sides of printed matters, so that the operator can securely and instantly make a separate determination of the necessity of the color correction for the front and rear sides, respectively.

According to another aspect of the present invention, there is provided a controller of a double-sided printing press equipped with ink feeders for controlling print density of a printed matter having front and rear sides printed by the double-sided printing press, according to a printing mode of the double-sided printing press, which includes: a display means for displaying a density deviation between a target density value and a density value of the printed matter for each of the ink feeders; an input means for arbitrarily selecting an ink feeder to be color corrected based upon density deviations of the respective printing units displayed by the display means; and an ink amount control means for controlling the ink amount of the ink feeder selected by the input means based upon a density deviation corresponding to the ink feeder. In this arrangement, the display means is capable of displaying a density deviation of the front side and a density deviation of the rear side; and the input means is capable of selecting an ink feeder for the front side and an ink feeder for the rear side from the ink feeders. Also, the display means is capable of selectively displaying the density deviation of the front side and the density deviation of the rear side when the double-sided printing press is in a double-sided printing mode, and displaying the density deviation of the front side when the double-sided printing press is in a single-sided printing mode.

With the controller having the above arrangement, when printed matters are controlled according to the printing mode, the screen can selectively display a panel displaying the density deviation of the front side and a panel displaying the density deviation of the rear side in a switchable manner in the double-sided printing operation, as well as displaying a panel displaying only the density deviation of the front side in the single-sided printing operation. Thus, the color correction operation suitable for each printing mode can be easily and securely performed.

### BRIEF DESCRIPTION OF THE DRAWINGS

The above, and other objects, features and advantages of the present invention will become apparent from the detailed description thereof in conjunction with the accompanying drawings wherein.

FIG. 1 is a structural view of a hardware of a print density controller according to a first embodiment of the present invention.

FIG. 2 is a schematic view illustrating the double-sided printing press.

FIG. 3 is a part of a flow chart of color correction program.

FIG. 4 is another part of the flow chart of the color correction program, following the part of FIG. 3.

FIG. 5 is a color setting screen for a single-sided printing displayed on a CRT of FIG. 1.

FIG. 6 is a measured result display screen displayed on the CRT of FIG. 1.

FIG. 7 is a feedback implementation screen displayed on the CRT of FIG.

FIG. 8 is a color setting screen for a front side in the double-sided printing displayed on the CRT of FIG. 1.

FIG. 9 is a color setting screen for a rear side in the double-sided printing displayed on the CRT of FIG. 1.

FIG. 10 is a measured result display screen for a front side in the double-sided printing displayed on the CRT of FIG. 1.

FIG. 11 is a measured result display screen for a rear side in the double-sided printing displayed on the CRT of FIG. 1.

### DESCRIPTION OF THE PREFERRED EMBODIMENTS

Embodiments of the print density controller of the double-sided printing press according to the present invention will be herein described with reference to the drawings attached hereto.

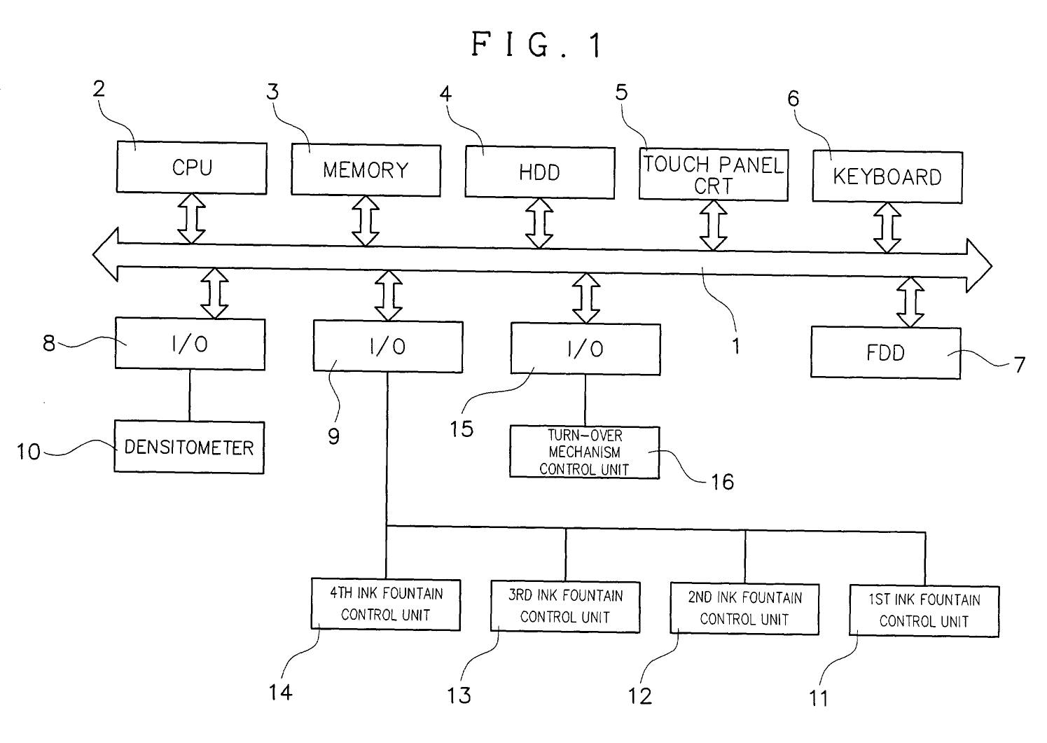

FIG. 1 illustrates the structural view of one example of a hardware of the print density controller achieved by using a CPU, according to the first embodiment of the present invention. In FIG. 1, bus line 1 is connected with CPU 2, memory 3, hard disk 4, FDD 7, keyboard 6 and touch panel CRT 5. The CPU 2 controls respective members or units via the bus line 1 according to a program stored in the hard disk 4. The memory 3 stores the previous printing mode, various set values, calculated results, etc.

The bus line 1 is also connected via interfaces 8, 9, 15 with densitometer 10, first to fourth ink fountain control units 11, 12, 13, 14 and turn-over mechanism control unit 16. The densitometer 10 measures color bars of printed matters and send their density values to the CPU 2.

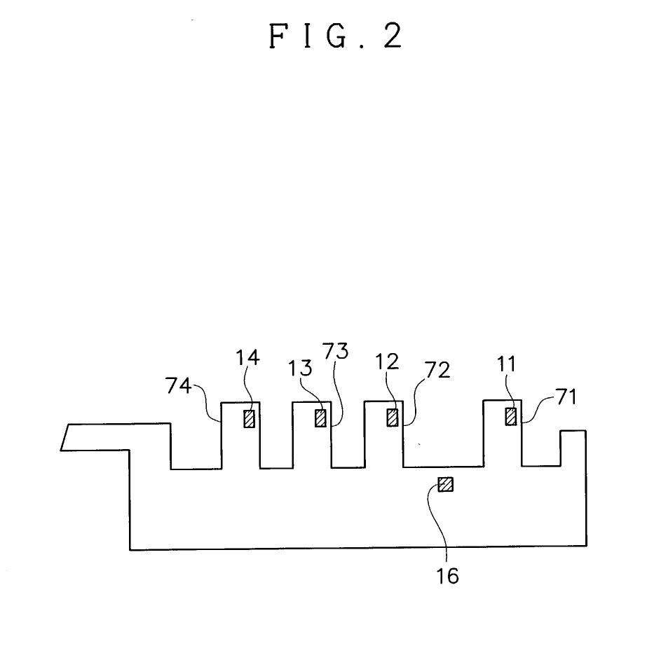

The double-sided printing press in this embodiment as illustrated in FIG. 2 includes printing units 71, 72, 73, 74, which are respectively provided with ink fountain control units 11, 12, 13, 14, which respectively control the amounts of inks in the corresponding ink feeders based upon signals received from the CPU 2 via the interface 9. The printing press also includes a turn-over mechanism between the first printing unit 71 and the second printing unit 72, and turn-over mechanism control unit 16 that controls the turn-over mechanism to switch a printing mode.

In this embodiment, the CRT 5, which is of a touch panel type, acts as a display means for displaying a density deviation between a target density value and a density value of printed matters in each ink feeder, and an input means for inputting an ink feeder, which printed a color to be corrected, based upon a density deviation of a corresponding ink feeder displayed by the display means. Thus, an ink feeder with its density value to be corrected is properly selected. The first to fourth ink fountain control units 11, 12, 13, 14 together act as an ink amount control means for controlling the amount of ink in the ink feeder selected by the input means, based upon the density deviation corresponding to this ink feeder. The touch panel CRT 5 acts as a measurement condition input means for inputting a measurement condition for measurement of density values of printed matters (described later). The keyboard 6 acts as a target value input means for inputting target density values and their tolerance values. The densitometer 10 acts as a density value measurement means for measuring density values of printed matters based upon the measuring condition inputted through the measurement condition input means. The CPU 2 acts as a density deviation calculation means for calculating a density deviation between density values measured by the density value measurement means and their target density values.

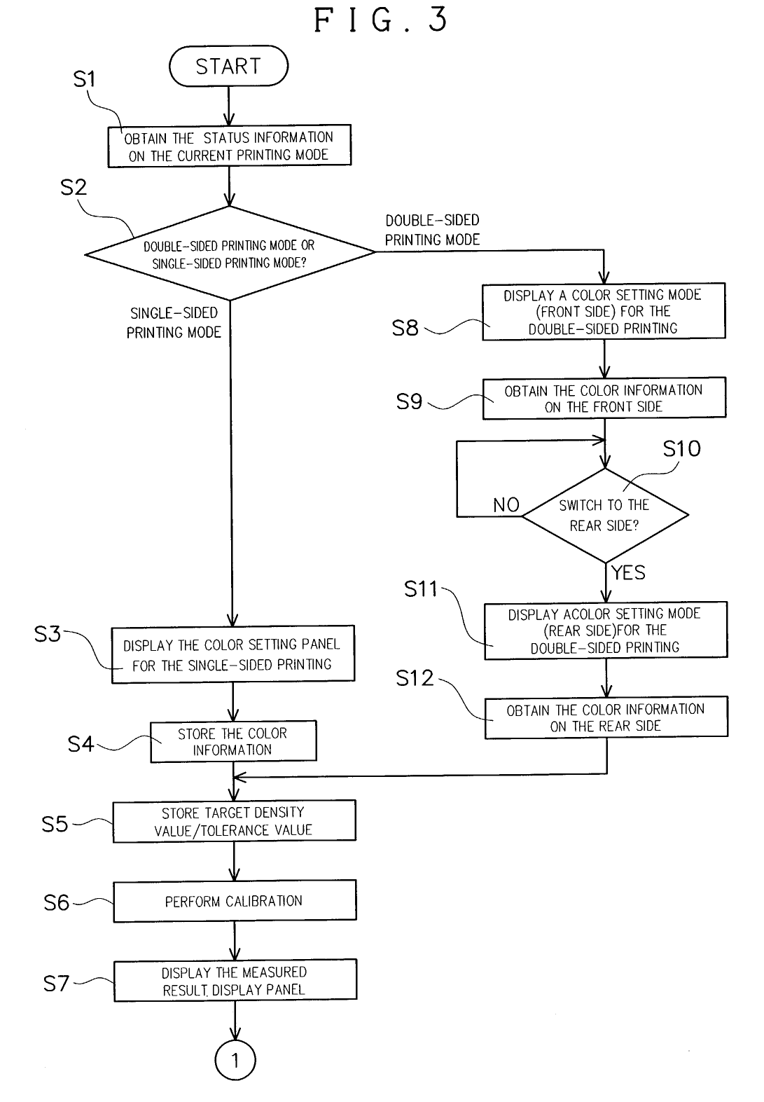

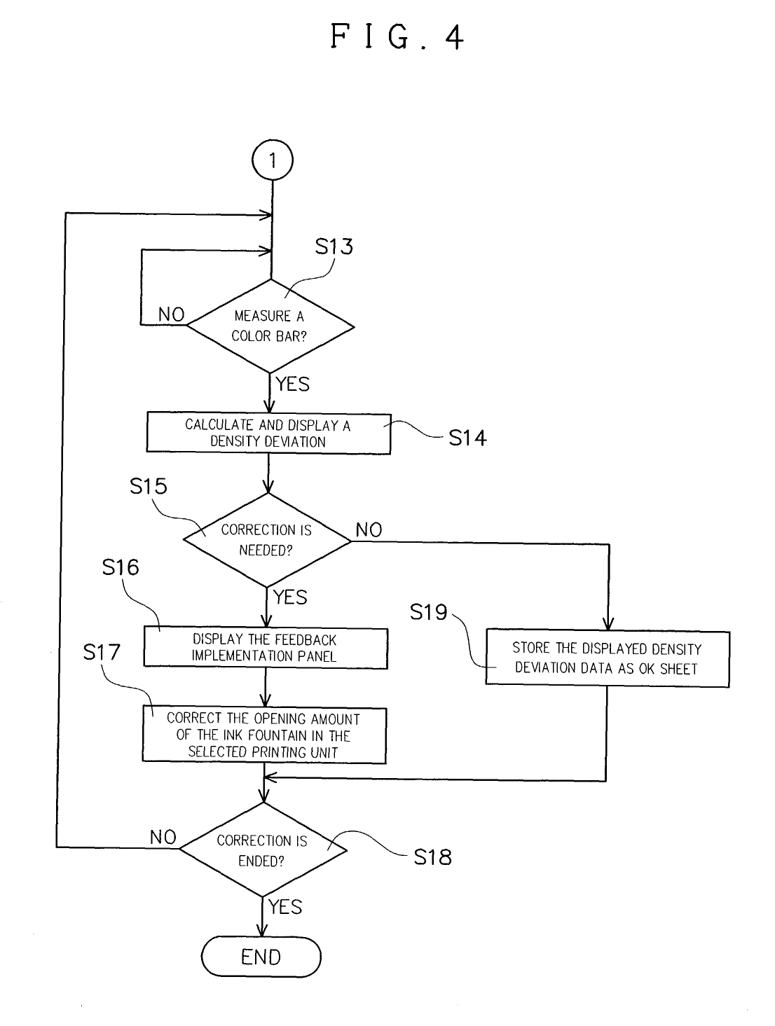

Now, the description will be made for the procedure of the color correction operation with reference to the flow charts of FIGS. 3 and 4. The CPU 2, which controls the respective members or units according to a color correction program stored in the hard disk 4, first obtains a status information on the current printing mode from the turn-over mechanism control unit 16 (Step S1). This status information represents the fact as to whether the printing press (the turn-over mechanism) is currently in the single-sided printing mode or the double-sided printing mode. When the printing mode is switched, the information on the current printing mode is sent to the CPU 2 from the turn-over mechanism control unit 16 upon finish of the printing mode switching operation. In this regard, the information on the previous printing mode stored in the memory 3 is read out, for example at the time of the activation of the printing press.

In Step S2, the CPU 2 determines whether the double-sided printing mode or the single-sided printing has been set, based upon the obtained status information of the printing mode, and proceeds with step S3 following a color correction mode for the single-sided printing when the printing press is set in the single-sided printing mode, or proceeds with step S8 following a color correction mode for a double-sided printing when the printing press is set in the double-sided printing mode.

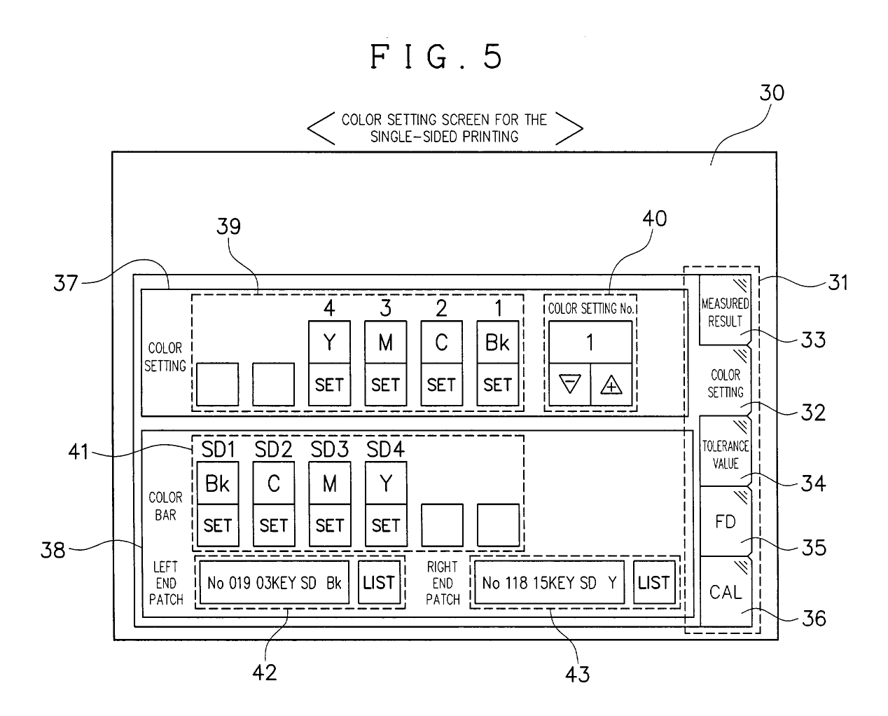

In Step S3, the CPU 2 enables the touch panel CRT 5 to display color setting panel 30 for the single-sided printing, as illustrated in FIG. 5. In this Figure, mode selection section 31 for selecting a mode to be proceeded is arranged along a right hand side end of the screen. The mode selection section 31 includes a total of five mode selection tabs, namely color setting mode tab 32 for setting a condition on measuring density values, measured result display mode tab 33 for displaying measured density deviations, tolerance value setting mode tab 34 for setting target values as target density values along with their tolerance values, FDD management mode tab 35 for management of data by the FDD 7, and calibration mode tab 36 for performing white correction according to the type of printed matters or sheets. The operator thus can select a mode to be displayed from these modes and display a screen corresponding to the mode selected on the CRT 5 by touching a corresponding tab.

In FIG. 5, the color setting panel (a panel for setting a measurement condition) 30 is to set a color information, which is a measurement condition for measuring density values of the printed matters, and includes color setting field 37 for setting ink colors used in the respective printing units 71, 72, 73, 74 (ink feeders), and color bar setting field 38 for setting a color bar information. The color setting field 37 is designed to enable allocation of the ink colors to the first to fourth printing units 71, 72, 73, 74 independently of each other on independent setting section 39. Alternatively, on the color setting field 37, the operator can set the ink colors for those printing units in a single setting operation, which involves selecting a suitable combination pattern on pattern setting section 40 from previously stored combination patters. The color bar setting field 38 includes color order setting section 41 for setting the alignment order of ink colors for each color bar in correspondence with ink colors used, and measurement range setting section for setting a measurement range of each color bar in measuring the color bar by the densitometer 10 (later described). This measurement range setting section is made up of leading end setting part 42 and tail end setting part 43 for respectively setting a leading end and a tail end of each measurement range. For example, where the first to fourth printing units respectively use black, cyan, magenta and yellow, the color setting field 37 and the color bar setting field 38 are set so as to match this color allocation on the color setting screen 30. Once the color information is inputted on the color setting screen 30 of the CRT 5 in this matter, the CPU 2 stores it in the memory 3 (Step S4).

Then, the operator touches the tolerance value setting mode tab 34 of the mode selection section to proceed from Step S4 to Step S5, in which the CPU 2 enables the CRT 5 to display a tolerance value setting panel on the screen. On this panel, the operator inputs a target density value along with its tolerance value for each ink color. The target density value and tolerance value used are properly determined for each of designs, patterns, graphics and the like based upon experience. The CPU 2 stores the necessary values such as a target value in the memory 3.

Then, the operator touches the calibration mode tab 36 of the mode selection section 31 so as to proceed to Step S6, enabling the CRT 5 to display a calibration panel. The calibration in this step is white calibration made on paper white (non-printed portion of sheets) before measuring a color bar, thereby avoiding influences by the color or texture of printed matters or sheets. The result of calibration is also stored in the memory 3.

Upon finish of the above steps, which are proceeded before the measurement of color bars, the operator touches the measured result display tab 33 of the mode selection section 31 on the CRT 5, while setting a printed matter with its printed front side on the densitometer 10, thereby starting the color bar measurement. The operator then touches the measured result display tab 33 of the mode selection section 31 so that the CPU 2 enables the CRT 5 to display measured result display panel 50 (Step S7).

Data representative of density values measured by the densitometer 10 are sent from the densitometer 10 via the interface 8 to the CPU 2, which then calculates a density deviation between the density value of a printed matter and the target value stored in Step 5 for each ink color. The calculated density deviation for each ink color is displayed on the measured result display panel 50 (Steps S13, S14).

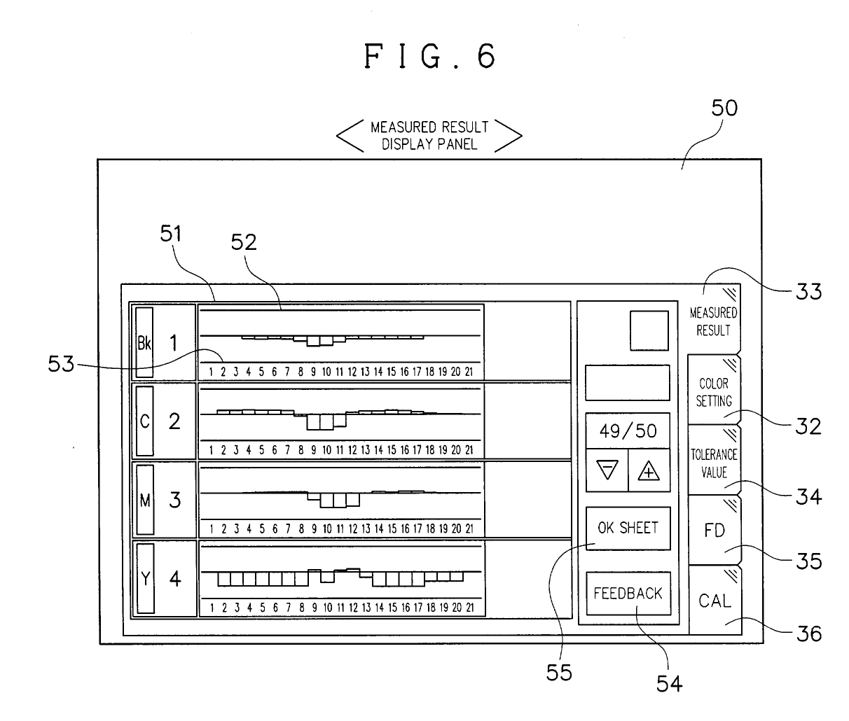

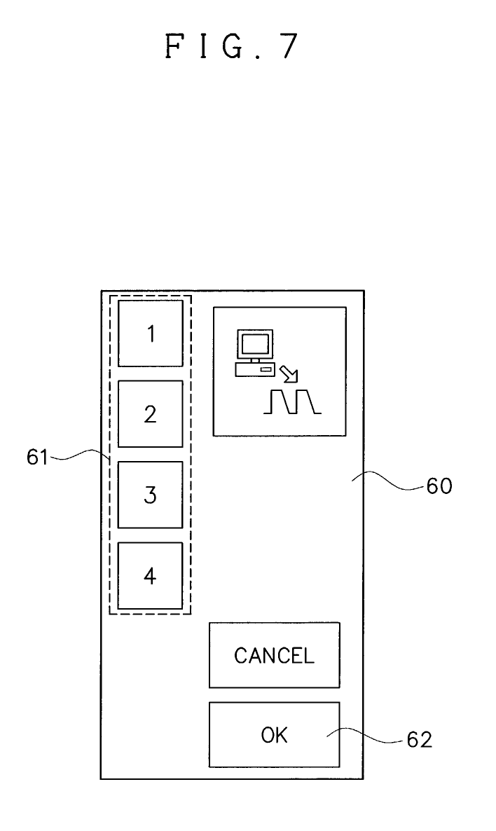

FIG. 6 illustrates one example of the measured result display panel 50, in which graph display section 51 for displaying data representative of density deviations in the respective ink colors in the form of graph. Each graph has a horizontal axis representing the alignment of the ink fountain keys and a vertical axis representing density values. In the vertical axis, a value on the positive side represents an increased amount of ink and a value on the negative side represents a decreased amount of ink. The positive and negative sides respectively indicate upper limit line 52 and lower limit line 53 of the tolerance value, enabling the operator to visually determine which ink fountain key contains an exceeding amount of ink with respect to the tolerance value. Thus, the measured result display panel 50 is of the type that the measured results of the printing units 71, 72, 73, 74 are all displayed on the same panel. The operator determines the necessity of the color correction for each printing unit based upon the data representative of density deviations displayed in the form of graph, and where it has been determined as such that the color correction should be made, feedback key 54 on the panel is touched, thereby proceeding from Step S15 to Step S16, in which the CPU 2 enables the CRT 5 to display feedback implementation panel 60, as illustrated in FIG. 7.

The operator touches unit selection key 61 on this feedback implementation panel 60 so that a printing unit for which color correction is needed can be selected. After the selection of the printing unit, OK key 62 is touched to implement feedback. By the touch of the OK key 62, the CPU 2 sends data representative of the density deviation of the selected printing unit to the ink fountain control unit of the selected printing unit via the interface 9. The ink fountain control unit controls the opening amount of the ink fountain in the selected printing unit based upon the data of the density deviation sent from the CPU 2, thereby increasing or decreasing the amount of ink to be fed to a corresponding press plate (Step S17). The density deviation data is for each ink fountain key and therefore the opening amount is controlled for each ink fountain key. The feedback implementation panel 60 is automatically closed by the touch of the OK key 62.

Where the color correction operation is to be continued, the operation returns from Step S18 to Step S13, in which the operator measures a printed matter later printed, in the same manner as described above, and determines whether the density value has approximated to the target value. This color correction operation is repeated until the density value approximates to the target value. Once the printed matter with the density value approximated to the target value has been produced after the repeated feedback, the operation proceeds from Step S15 to Step S19, in which this printed matter is set as an OK sheet by OK-sheet setting key 55. The operation subsequent to this step is performed to produce a print density equivalent to the OK sheet, and is performed for example every 100 sheets in printing 1000 sheets. The CPU 2 stores a density value, which has been determined as the value of the printed matter approximated to the target value, as a density value of the OK sheet in the memory 3. The density value of this OK sheet is designated as the target density value in the subsequent color correction operation, and the CPU 2 calculates the density deviation between the density value of the printed matter and the density value of the OK sheet, and displays the calculated result on the measured result display panel 50.

Now, the description will be made for the procedure in the double-sided printed mode.

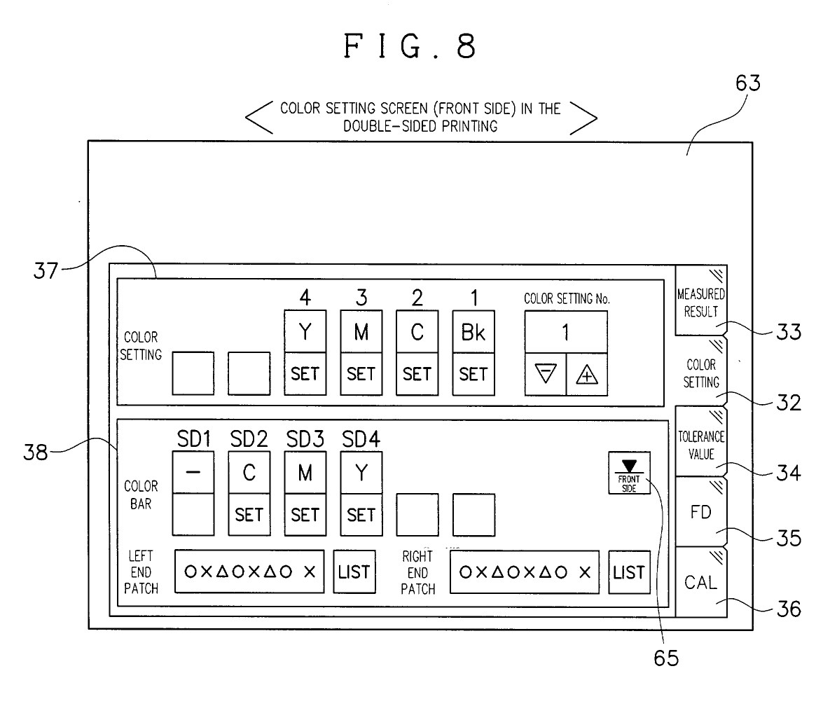

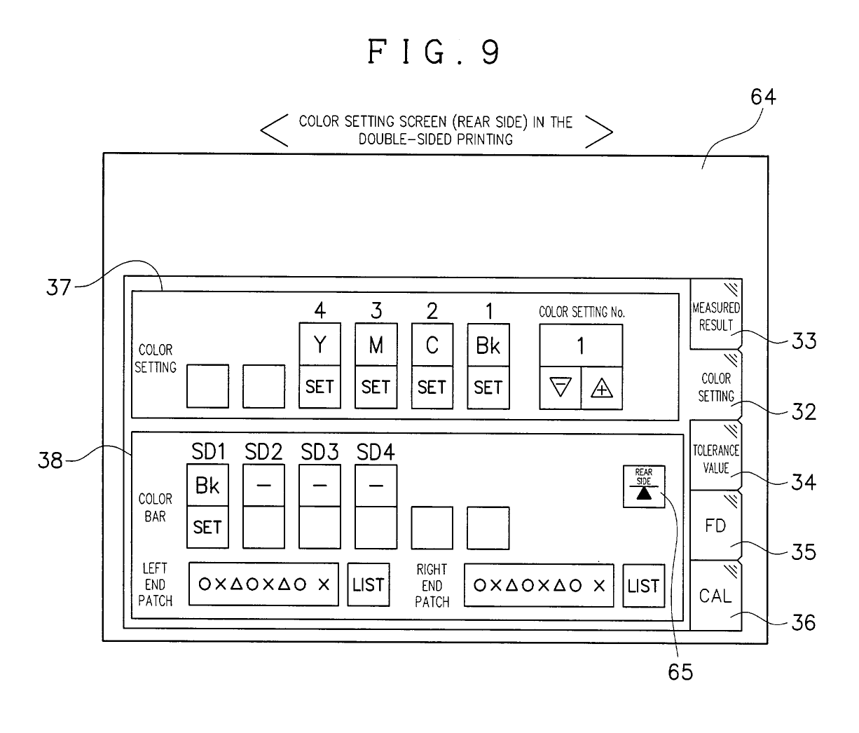

When the double-sided printing operation is to be performed, the operation proceeds from Step S2 to Step S8, in which the CPU 2 enables the CRT 5 to display a color setting mode for the double-sided printing. This color setting mode is made up of two panels, that is, color setting panel 63 for a front side (hereinafter referred to a front-side color setting panel) and color setting panel 64 for a rear side (hereinafter referred to a rear-side color setting panel), as illustrated in FIGS. 8 and 9. These panels can be switched by touching front/rear switching key 65, which acts as a switching means. A difference in function between two panels exists in the color bar setting field 38 so as to apply different measurement conditions to the front and rear sides of printed matters. Accordingly, in the double-sided printing operation, the information of color bars on the both sides of printed matters are respectively inputted on the color setting panels 63, 64. Thus, the CRT 5 selectively displays the front-side color setting screen 63 and the rear-side color setting screen 64 in the double-sided printing operation. On the other hand, in the single-sided printing operation, the CRT 5 displays the color setting panel 30, which has no front/rear switching key.

In Step S8, the CPU 2 first enables the CRT 5 to displays the firs-side color setting screen 63, then stores an inputted color information on the front side in the memory 3 (Step S9), then proceeds from Step S10 to Step S11 upon receiving input signals from the front/rear switching key 65, enabling the CRT 5 to switch its screen to the rear-side color setting panel 64, and then stores an inputted color information on the rear side in the memory 3 (Step S12).

Subsequently, in Step S5 and Step S6, storing a target value and a tolerance value, and calibration are implemented in the same manner as the single-sided printing operation. Since the same target value and tolerance value, and calibration can be applied to both sides of printed matters, the operator only follows the inputting operation as done in the single-sided printing operation.

Then, the CPU 2 enables the CRT 5 to display the measured result display panel 50 (Step S7) in the same manner as the single-sided printing operation, and then display a density deviation calculated based upon the measured color bar of the front side (Steps S13, S14). Since the memory 3 stores the color information of both sides, the operator can successively measure a color bar on the rear side subsequent to the measurement of the color bar on the front side. For example, upon finishing the measurement of the color bar on the front side, the CPU 2 calculates a density deviation with respect to the target value based upon density value data for each color on the front side sent from the densitometer 10, and displays the calculated density values on the measured result display panel 50. That is, graph display section 51 displays density deviation data in the form of bar graph in the respective display areas for the second to fourth printing units 72, 73, 74. Then, upon finishing the measurement of the color bar on the rear side, density deviation data of the first printing unit 71 is likewise displayed on its display area. That is, all of the density deviation data of the four printing units are simultaneously displayed on the measured result display panel 50 in the same manner as the single-sided printing operation. Accordingly, the operator can determine the necessity of color correction for all the printing units based upon simultaneous observation of the density deviation data of the front side and rear side displayed on the same panel. For example, where it has been determined that the first printing unit 71 for the rear side and the third printing unit 73 in the printing units for the front side must be color corrected, the feedback implementation panel 60 is opened by touching the feedback key 54, thereby selecting the first and third printing units 71, 73 by touching corresponding unit selection keys 61. Upon selection of these units, the CPU 2 sends signals to the first and third printing units 71, 73, thereby enabling the ink fountain control units 11, 13 to control the ink amounts of these units based upon the respective density deviation data. Thus, all the selected printing units can simultaneously proceed with color corrections for the front and rear sides.

Granted that only the printing unit(s) for the front side must be color corrected, or only the printing unit for the rear side must be color corrected, the color correction can be made only for these printing units by the selection of these units. Once the respective density values on both sides have been approximated to the target value, the printed matter used here is stored as an OK sheet in the memory 3.

Since the color information of the front side and that of the rear side in the double-sided printing operation can be set in one sequence, both sides of a printed matter which were printed can be successively measured. The measured results of both sides are displayed on the CRT 5. When a printing unit or printing units to be color corrected are selected from the displayed units, it is possible to select a printing unit of the front side and a printing unit of the rear side at a time. This enables the color correction of the printing units for both sides at a time. Whereby, it is possible to achieve an efficient color correction operation in a short period of time as compared with a conventional operation, which necessitates separate and independent color corrections for the respective sides of printed matters. Particularly, the density deviation data of the printing units for the front and rear sides simultaneously displayed on a single panel enables the operator to instantly determine the necessity of the color correction for the both sides through the observation of the data on a single panel.

In this embodiment, the measured result display panel 50 is so designed that the data of all the printing units are displayed on a single screen regardless of the printing mode. Alternatively, it may be so designed that a measured result display panel 50 for the single-sided printing operation (a panel displaying a density deviation of the front side) and a measured result display screen for the double-sided printing operation are selectively displayed according to the printing mode.

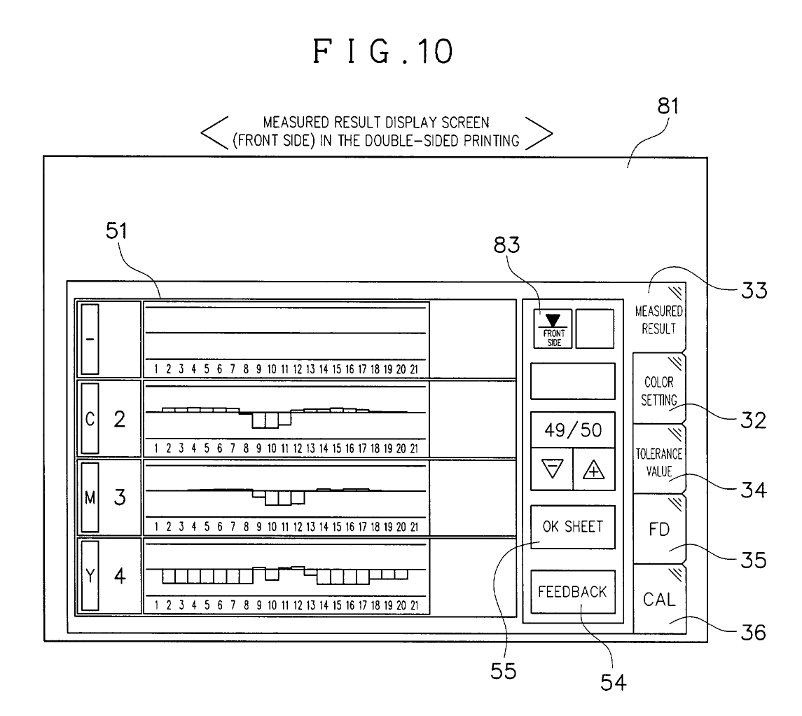

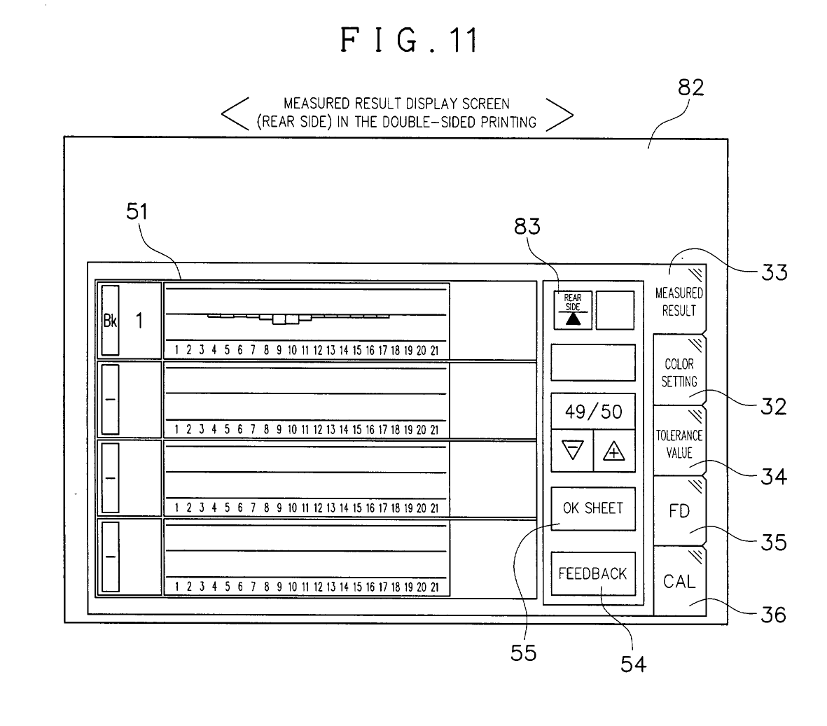

As an example of the measured result display mode for the double-sided printing in the above arrangement, it may be made up of front-side display panel 81 and second-side display panel 82 for respectively displaying density deviations of the front and rear sides, which are arbitrarily switched by the operator through the operation of front/rear switching key 83. That is, as illustrated in FIGS. 10 and 11, the front/rear switching key 83 appears as a switching means at an upper and right hand side of each of the measured result display panels 81, 82 for the double-sided printing. FIG. 10 illustrates the front-side display screen 81 displaying only the density deviation data of the second to fourth printing units 72, 73, 74. By the touch of the front/rear switching key 83, the screen is switched to the rear-side display panel 82, as illustrated in FIG. 11, in which only the density deviation data of the first printing unit 71 is displayed. The measured results of the front side and rear side in the double-sided printing operation can thus be displayed on the two panels, which are selectively displayed on the CRT 5. Although the switching operation is required, the density deviation data of the front and rear sides are also displayed on the CRT 5, and the data of all the printing units 71, 72, 73, 74 are displayed, as illustrated in FIG. 7, on the feedback implementation panel 60, which is opened by touching the feedback key 54. Accordingly, the color correction can be simultaneously made for the front and rear sides through selection of the printing units in one sequence for the front and rear sides to be color corrected from all the printing units. As an additional advantage, the separate or independent display of the density deviation data for the front and rear sides enables the operator to securely recognize which of the front and rear sides the data displayed on the screen represent. Therefore, the operator can securely make a separate determination of the necessity of the color correction for the front and rear sides, respectively.

Providing screens exclusively designed for displaying measured results in the single-sided printing and double-sided printing advantageously prevents the operator from falsely recognizing the printing mode in the ongoing color correction operation, so that the color correction operation suitable for each printing mode can be easily and securely performed.

Also, it is possible to easily identify whether the current screen displays the data for the single-sided printing or the double-sided printing, by confirming the presence of the front/rear switching key 83 (switching means). Likewise, the operator can easily identify whether the color setting panel displays the data for the single-sided printing or the double-sided printing, by the confirmation of the presence of the front/rear switching key 65 (switching means).

Although the touch panel CRT 5 is used as a means for inputting an object to be corrected in this embodiment, it is possible to use various types of input means such as keyboard 6. Likewise, the display means is not necessarily limited to the touch panel CRT 5. Display means such as CRT having no inputting function, and LCD (liquid crystal display) can be used.

The number of the printing units, mounting position of the turn-over mechanism and any other matters related to the construction or design of the printing press may be properly varied. For example, two printing units may constitute a printing means, which prints in two colors when in the single-sided printing and print in one color on each side of a printed matter when in the double-sided printing, thus making themselves available for a double-sided printing press. Also, it is not necessary to provide a single ink feeder per one printing unit. In either arrangement, the determination of the necessity of the color correction is made to each ink feeder. Density deviations displayed on the CRT 5 may take various forms other than graph, such as numeric representation.

The controller of the present invention may be so designed that the CPU 2 calculates density values based upon measured data sent from the densitometer 10.

Also, the above description was made for the arrangement in which the controller of the print density is equipped with the densitometer 10 and the CPU 2 calculates density deviations based upon measured density values sent from the densitometer 10. The equipping of the densitometer in the controller is not necessarily. Alternatively, a densitometer may be separately provided so that density values measured by this separately provided densitometer are inputted in the controller such as through a flexible disc. Data representative of density deviations may be calculated by a different machine or unit, and inputted in the controller.

This specification is by no means intended to restrict the present invention to the preferred embodiments set forth therein. Various modifications to the controller, as described herein, may be made by those skilled in the art without departing from the spirit and scope of the present invention as defined in the appended claims.

What is claimed is:

1. A controller of a double-sided printing press equipped with ink feeders for controlling print density of a printed matter having front and rear sides printed by the double-sided printing press, which comprises:
a display means for displaying a density deviation between a target density value and a density value of the printed matter for each of the ink feeders;
an input means for arbitrarily selecting an ink feeder to be color corrected based upon density deviations of the respective printing units displayed by the display means; and
an ink amount control means for controlling the ink amount of the ink feeder selected by the input means based upon a density deviation corresponding to said ink feeder; wherein
said display means is capable of displaying a density deviation of the front side and a density deviation of the rear side, and the input means is capable of selecting an ink feeder for the front side and an ink feeder for the rear side from the ink feeders.

2. The controller according to claim 1, wherein said display means displays the density deviation of the front side and the density deviation of the rear side on a single panel in an integral manner.

3. The controller according to claim 1, wherein said display means selectively displays a panel that displays the density deviation of the front side and a panel that displays the density deviation of the rear side.

4. A controller of a double-sided printing press equipped with ink feeders for controlling print density of a printed matter having front and rear sides printed by the double-sided printing press, according to a printing mode of the double-sided printing press, which comprises:
a display means for displaying a density deviation between a target density value and a density value of the printed matter for each of the ink feeders;
an input means for arbitrarily selecting an ink feeder to be color corrected based upon density deviations of the respective printing units displayed by the display means; and
an ink amount control means for controlling the ink amount of the ink feeder selected by the input means based upon a density deviation corresponding to said ink feeder; wherein
said display means is capable of displaying a density deviation of the front side and a density deviation of the rear side; and the input means is capable of selecting an ink feeder for the front side and an ink feeder for the rear side from the ink feeders, and
said display means is capable of selectively displaying the density deviation of the front side and the density deviation of the rear side when the double-sided printing press is in a double-sided printing mode, and displaying the density deviation of the front side when the double-sided printing press is in a single-sided printing mode.
